(19) United States
(12) Patent Application Publication
(10) Pub. No.: US 2013/0088851 A1
(43) Pub. Date: Apr. 11, 2013

(54) LIGHTING MODULE AND LIGHTING DEVICE THEREOF

(71) Applicant: DELTA ELECTRONICS, INC., Taoyuan Hsien (TW)

(72) Inventors: Horng-Jou WANG, Taoyuan Hsien (TW); Shang-Ping YEH, Taoyuan Hsien (TW)

(73) Assignee: DELTA ELECTRONICS, INC., Taoyuan Hsien (TW)

(21) Appl. No.: 13/646,296

(22) Filed: Oct. 5, 2012

(30) Foreign Application Priority Data
Oct. 5, 2011 (TW) 100135987

(51) Int. Cl. F21V 13/14; F21V 13/08; F21V 29/00; F21V 5/00; F21V 13/04

(52) U.S. Cl. 362/84; 362/244; 362/245

(57) ABSTRACT

A lighting device is provided, which includes a substrate, at least one lighting element and at least one optical element. The lighting element is disposed on the substrate, wherein the lighting element produces light. The optical element, disposed on a light-emitting path of the light, wherein the optical element includes a base and a refractive portion. The base includes a first end and second end, wherein the second end is thinner than the first end. The refractive portion is connected to the second end of the base, wherein the refractive portion includes a curved surface.

### CROSS REFERENCE TO RELATED APPLICATIONS

This Application claims priority of Taiwan Patent Application No. 100135987, filed on Oct. 5, 2011, the entirety of which is incorporated by reference herein,

### BACKGROUND OF THE INVENTION

1. Field of the Invention

The present invention relates to a lighting device, and in particular relates to a lighting device utilizing a light-emitting diode as the light source.

2. Description of the Related Art

FIG. 1 shows a conventional lighting device 1, comprising a light source 10 and a lens 20. The lens 20 has a light-entering surface 21 and a light-emitting surface 22. The area of the light-emitting surface 22 is greater than the area of the light-entering surface 21. A gap is formed between the light-entering surface 21 and the light source 10. A light beam is emitted from the light source 10, and enters the lens 20.

Conventionally, a second-order optical lens is utilized to modify the shape of the light beam, which incurs increased cost and causes more secondary optical efficiency loss.

### BRIEF SUMMARY OF THE INVENTION

The invention provides a lighting device, which utilizes a first-order optical element to provide a particular light shape.

In one embodiment, a lighting device is provided, which comprises a substrate, at least one lighting element and at least one optical element. The lighting element is disposed on the substrate, wherein the lighting element produces light. The optical element is disposed on a light-emitting path of the light, wherein the optical element comprises a base and a refractive portion. The base comprises a first end and second end, wherein the second end is thinner than the first end. The refractive portion is connected to the second end of the base, wherein the refractive portion comprises a curved surface.

In one embodiment, a cross-section area of the base increases from the second end to the first end, and the cross-section area of the second end of the base is smaller than the cross-section area of the first end of the base. The optical element is disposed on another side of the substrate opposite to the lighting element. The lighting element is disposed on or near the first end of the optical element. The distance between the first end of the optical element and the lighting element is smaller than the distance between the second end of the optical element and the lighting element.

In one embodiment the periphery of the base comprises a conical inclined plane firmed between the first end and the second end, and the curved surface of the refractive portion is integrally and smoothly formed with the conical inclined plane of the base. The conical inclined plane of the base reflects the light emitted from the lighting element, and the refractive portion refracts the light. The base has a central axis that passes through the first end and the second end. The curved surface of the refractive portion is a spherical surface, and the center of the spherical surface is located on the central axis. The optical element is disposed on the path of the light, and the light of the lighting element is refracted by the refractive portion toward the central axis.

In one embodiment, the lighting element has an effective lighting distance, and the curvature radius of the spherical surface is times the effective lighting distance. A circular surface is formed on the first end of the optical element, and a radius of the circular surface is 5˜7 times the effective lighting distance. A height is formed between the first end and the second end of the base, and the height is 4˜9 times the effective lighting distance.

In one embodiment, the lighting device can further comprise a reflective cup, wherein the lighting element is disposed in the reflective cup, and the reflective cup reflects the light generated by the lighting element. The reflective cup is formed, on a recess of the substrate.

In one embodiment, the lighting device can farther comprise a layer of phosphor powder covering at least a portion of the lighting element to change the wavelength of the light provided by the lighting element. The phosphor powder layer is disposed between the lighting element and the optical element. In one example, the phosphor powder layer can only cover a top portion of the lighting dement, and a side portion of the lighting element is exposed. In another example, the phosphor powder layer covers the Lop portion and the side portion of the lighting element, in yet another example, the lighting element is filled into the recess of the substrate.

In one embodiment, the optical element can be integrally formed. The lens of the embodiment can be made of Silicone, Epoxy, a mixture of silica gel and Epoxy, macromolecule material, glass or other transparent material. The surface of the lens can be roughened, or a diffusion film can be applied on the surface of the lens.

In one embodiment, the lighting element is a light-emitting diode (LED). The substrate is a metal core printed circuit board, a ceramic substrate, a direct copper bonded ceramic substrate, a copper substrate or a copper alloy substrate. The heat generated by the lighting element can be rapidly removed by the substrate.

In another embodiment, the invention provides a lighting module, comprises a heat sink, and the lighting device mentioned above, and the lighting device is disposed on the heat sink.

In one embodiment, the lighting module further comprises a cover: a recess is formed on the heat sink to receive the lighting element, and the cover covers the recess.

In one embodiment, the optical element can be a first-order optical lens to provide a particular light shape (for example, a condensing light shape or a divergent light shape), and a second-order optical lens is therefore avoided. The optical element of the embodiment of the invention is easily manufactured, and has a simpler shape and reduced cost. Additionally, the lighting element is disposed on the substrate, and the beat generated by the lighting element can be rapidly removed.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a conventional lighting device;

FIG. 2 shows a lighting device of the first embodiment of the invention;

FIG. 3A is a top view of the lighting device of the first embodiment of the invention;

FIG. 3B shows the light shape of the lighting device of the first embodiment of the invention;

FIGS. 4A˜4C show arrangements of lighting elements of embodiments of the invention;

FIG. 5 shows a lighting device of the second embodiment of the invention;

FIG. 6 shows a lighting device of the third embodiment of the invention;

FIGS. 7A˜7C show different phosphor powder layer arrangements;

FIG. 8 shows a lighting device of the fourth embodiment of the invention; and

FIG. 9 shows a lighting module of the fifth embodiment of the invention.

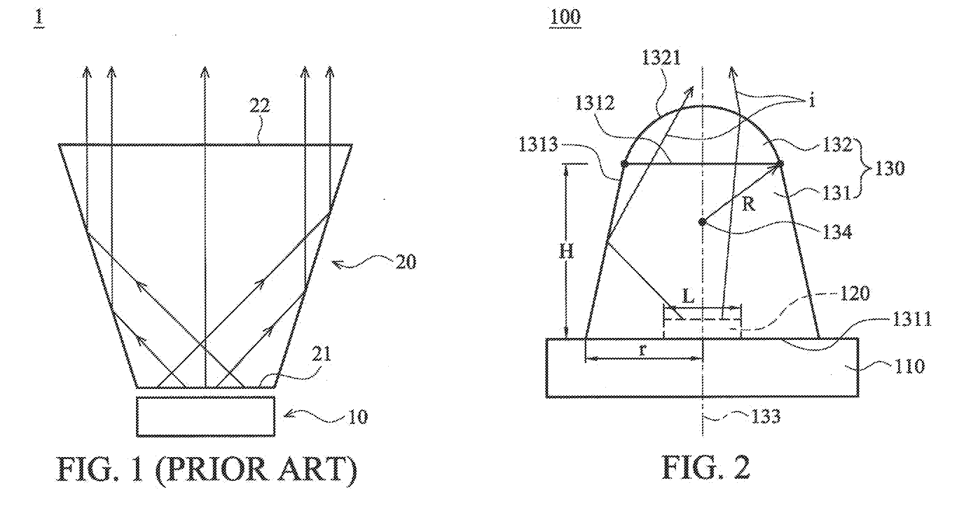

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

FIG. 2 shows a lighting device 100 of the first embodiment of the invention, which comprises a substrate 110, at least one lighting element 120 and an optical element 130. The lighting element 120 is disposed on the substrate 110, wherein the lighting element 120 produces light. The optical element 130 is disposed on a light-emitting path of the light. The optical element 130 comprises a base 131 and a refractive portion 132. The base 131 comprises a first end 1311 and second end 1312, wherein the second end 1312 is thinner than the first end 1311. That is, the cross-section area of the second end 1312 of the base 131 is smaller than the cross-section area of the first end 1311 of the base 131. The refractive portion 132 is connected to the second end 1312 of the base 131, wherein the refractive portion 132 comprises a curved surface 1321.

The lighting element 120 is disposed on the first end 1311 of the optical element, or near the first end 1311 of the optical element 120. A distance between the first end 1311 of the optical element 130 and the lighting element 120 is smaller than a distance between the second end 1312 of the optical element 130 and the lighting element 120. The periphery of the base 131 comprises a conical inclined plane 1313 formed between the first end 1311 and the second end 1312, and the curved surface 1321 of the refractive portion 132 is integrally and smoothly formed with the conical inclined plane 1313 of the base 131. The conical inclined plane 1313 of the base 131 reflects the light emitted from the lighting element 120, and the refractive portion 132 refracts the light. The base 131 has a central axis 133, and the central axis 133 passes through the first end 1311 and the second end 1312. The curved surface 1321 of the refractive portion 132 is a spherical s and the cerates 134 of the spherical surface is located on the central axis 133. The optical element 130 is disposed on the path of the tight, and the light of the lighting element 120 is refracted by the tote refractive portion 132 toward the central axis 133.

The lighting element 120 has an effective lighting distance L, and curvature radius R of the spherical surface is 1-6 times the effective lighting distance L. A circular surface is formed on the first end 1111 of the optical element 120, and a radius r of the circular surface is 5˜7 times the effective lighting distance L. A height H is formed between the first end 1311 and the second end 1112 of the base 131, and the height H is 4˜9 times the effective lighting distance L.

In the embodiment, the base 131 and the refractive portion 132 can be integrally formed. The optical element 130 can be a fast-order optical lens to provide a particular light shape (for example, a condensing light shape of a divergent light shape), and a second-order optical lens is therefore avoided. The optical element of the embodiment of the invention is easily manufactured, and has a simpler shape and reduced cost. Additionally, the lighting element is disposed on the substrate 110, and the heat generated by the lighting element 120 can be rapidly removed. The lens of the embodiment can he made of Silicone, Epoxy, a mixture of silica gel and Epoxy, macromolecule material, glass or other transparent material.

In the embodiment above, the lighting element 120 is a light-emitting diode (LED). The substrate 110 is a mental core printed circuit board, a ceramic substrate, a direct copper bonded ceramic substrate, a copper substrate or a copper alloy substrate. The heat generated by the lighting element 120 can be rapidly removed by the substrate 110.

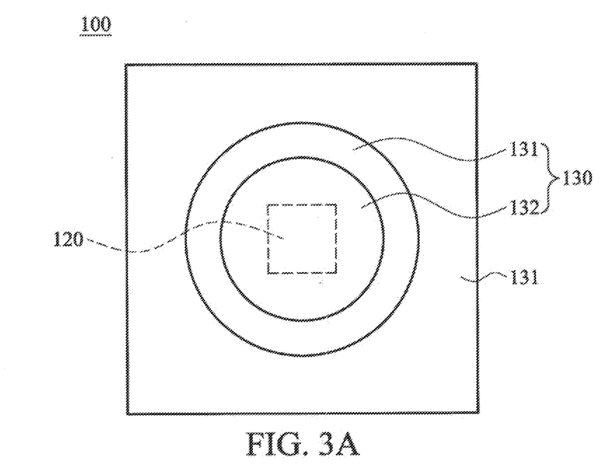

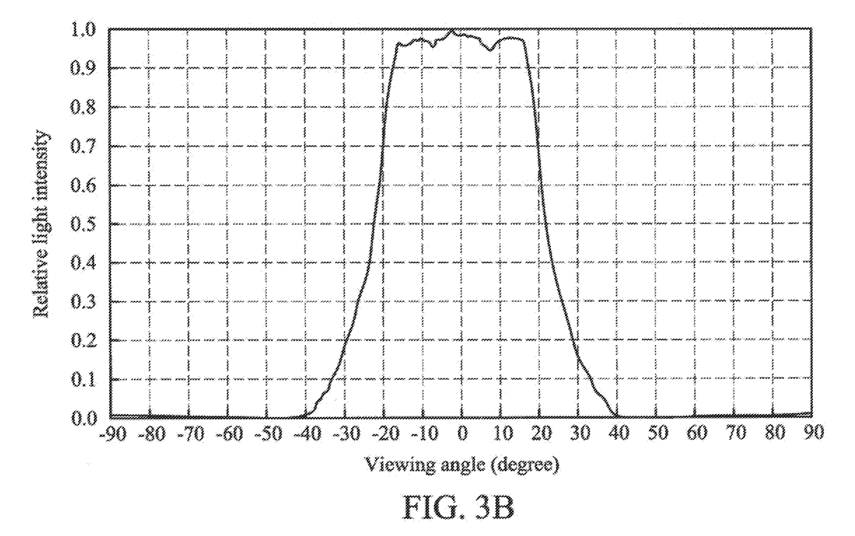

FIG. 3A is a top view of the first embodiment of the invention, wherein the lighting device 100 has only one lighting element 120. With reference to FIG. 3B, with proper design of the optical element, a condensing light shape can be achieved. In this embodiment, the conical inclined plane 1313 of the base 131 modulates high-angle light emitted from the lighting element 120. The high-angle light is reflected by the conical inclined plane 1313 of the base 131 to be transferred into low-angle light according to Snell's Law.

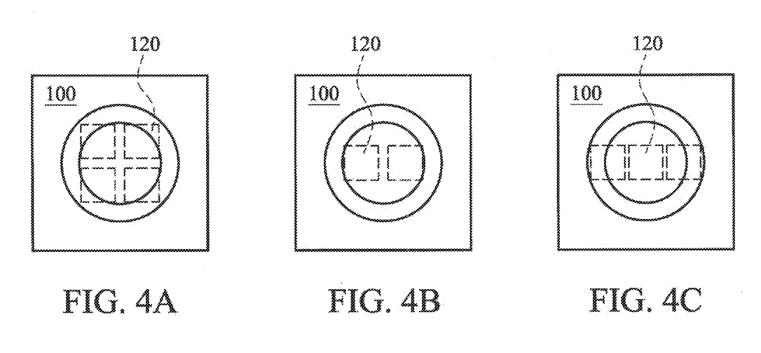

With reference to FIGS. 4A˜4C, the exposure amount of the lighting element 120 can be changed, and the arrangement thereof can be modified to provide different light shapes. The lighting element 120 can have horizontal-type die structure, vertical-type die Structure, flip-chip type die structure, flip-chip type like die structure or other die structures.

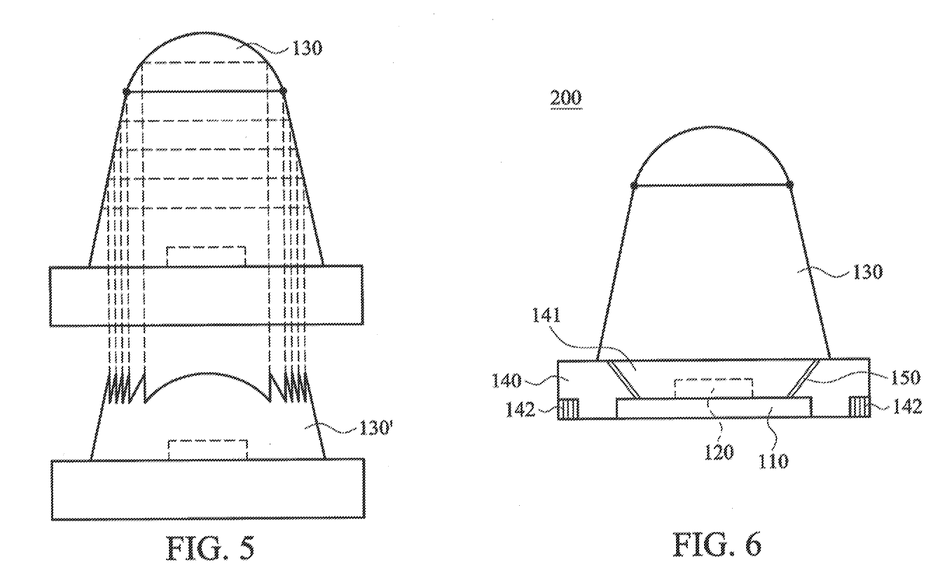

FIG. 5 shows the second embodiment of the invention, wherein an optical clement 110 is utilized, which is equivalent to the optical element 130 and is designed using Fresnel lens.

FIG. 6 shows a lighting device 200 of the third embodiment of the invention, which comprises a substrate 140. A recess 141 is formed on the substrate 140. The lighting element 120 is disposed in the recess 141. The inner wall of the recess 141 forms a reflective cap 150 to control reflection angles of the light. Electrodes 143 are formed on the substrate 140, and electrically connected to the lighting element 120.

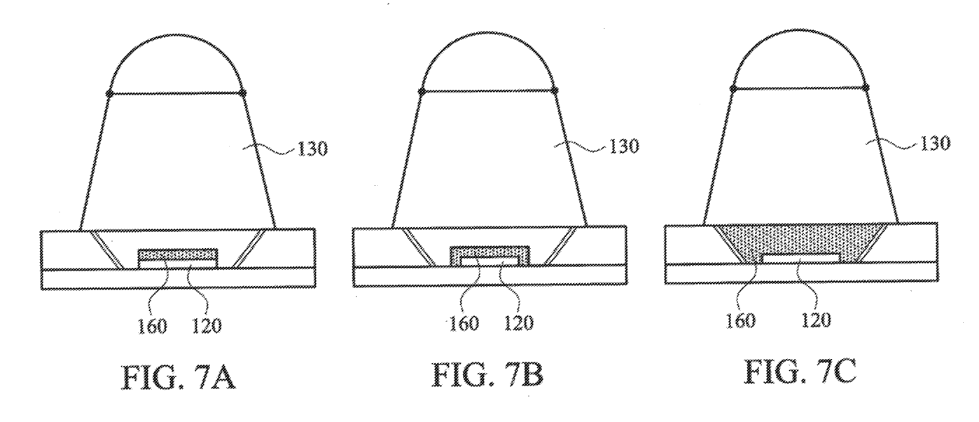

With reference to FIGS. 7A˜7C, the lighting device 200 can further comprise a phosphor powder layer 160, covering at least a portion of the lighting element 130 to change the wavelength of the light provided by the lighting element 120. The phosphor powder layer 160 is disposed between the lighting element 120 and the optical element 130. In one example, the phosphor powder layer 160 can only cover a top portion of The lighting element 120, and a side portion of the lighting element 120 is exposed (FIG. 7A). In another example, the phosphor powder layer 160 covers the top portion and the side portion of the lighting clement 120 (FIG. 7B). In yet another example, the lighting element 120 is filled into the recess of the substrate (FIG. 7C).

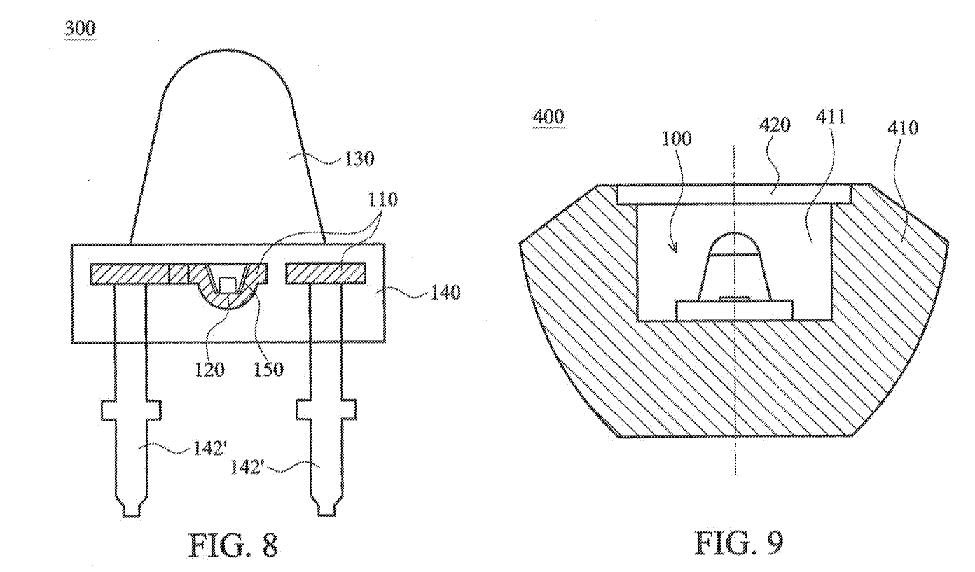

FIG. 8 shows a lighting device 300 of the fourth embodiment of the invention, wherein the lighting device 300 has a conductive lead 142′.

The optical element 130 can be integrally formed. The surface of the lens can be roughened, or a diffusion film can be applied on the surface of the lens.

FIG. 9 shows a lighting module 400 of the fifth embodiment of the invention, which comprises the lighting device 100 mentioned above, a heat sink 410 and a cover 420. The lighting device 100 is disposed on the heat sink 410. The heat sink 410 has a recess 411, the lighting element 100 is disposed in the recess 411, the cover 420 covers the recess 411, and the cover 420 is made of transparent material.

In the embodiments above, the shape of the optical element can be modified according to machining or manufacturing requirements, and the embodiments above do not restrict the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore the scope of the appended claims should be accorded the broadest interpretation so as to encompass all such modifications and similar arrangements.

1. A lighting device, comprising:
a substrate;
at least one lighting element, disposed on the substrate, wherein the lighting element produces light;
at least one optical element, disposed on a light-emitting path of the light, wherein the optical element comprises:
a base, comprising a first end and second end, wherein the second end is thinner than the first end; and
a refractive portion, connected to the second end of the base, wherein the refractive portion comprises a curved surface.

2. The lighting device as claimed in claim 1, further comprising a reflective cup, wherein the lighting element is disposed in the reflective cup, and the reflective cup reflects the light generated by the lighting element.

3. The lighting device as claimed in claim 2, wherein the reflective cup is a recess formed on the substrate.

4. The lighting device as claimed in claim 3, further comprising a phosphor powder layer, wherein the phosphor powder layer is filled in the recess.

5. The lighting device as claimed in claim 1, further comprising a phosphor powder layer, covering at least a portion of the lighting element to change the wavelength of the light.

6. The lighting device as claimed in claim 5, wherein the phosphor powder layer covers the top portion of the lighting element, and the side portion of the lighting element is exposed or covered by the phosphor powder layer.

7. The lighting device as claimed in claim 1, wherein the lighting element is disposed on or near the first end of the optical element.

8. The lighting device as claimed in claim 7, wherein a distance between the first end of the optical element and the lighting element is smaller than a distance between the second end of the optical element and the lighting element.

9. The lighting device as claimed in claim 1, wherein the optical element is disposed on another side of the substrate opposite to the lighting element.

10. The lighting device as claimed in claim 1, wherein a cross-section area of the base increases from the second end to the first end, and the cross-section area of the second end of the base is smaller than the cross-section area of the first end of the base.

11. The lighting device as claimed in claim 1, wherein the base comprises a conical inclined plane formed between the first end and the second end, and the curved surface of the refractive portion is integrally formed with the conical inclined plane of the base.

12. The lighting device as claimed in claim 11, wherein the conical inclined plane reflects the light emitted from the lighting element, and the refractive portion refracts the light.

13. The lighting device as claimed in claim 12, wherein the base has a central axis, the central axis passes through the first end and the second end, the curved surface of the refractive portion is a spherical surface, and the center of the spherical surface is located on the central axis.

14. The lighting device as claimed in claim 13, wherein the lighting element has an effective lighting distance L, and a curvature radius R of the spherical surface is 1˜6 times the effective lighting distance L.

15. The lighting device as claimed in claim 13, wherein the light of the lighting element is refracted by the refractive portion toward the central axis.

16. The lighting device as claimed in claim 1, wherein the lighting element has an effective lighting distance L, a circular surface is formed on the first end of the optical element, and a radius r of the circular surface is 5˜7 times the effective lighting distance L.

17. The lighting device as claimed in claim 1, wherein the lighting element has an effective lighting distance L, a height H is formed between the first end and the second end of the base, and the height H is 4˜9 times the effective lighting distance L.

18. The lighting device as claimed in claim 1, wherein the base and the refractive portion are integrally formed.

19. A lighting module, comprising:
a heat sink;
the lighting device as claimed in claim 1, disposed on the heat sink.

20. The lighting module as claimed in claim 19, further comprising a cover, a recess is formed on the heat sink to receive the lighting element, and the cover covers the recess.
